(19) United States
(12) Patent Application Publication
(10) Pub. No.: US 2005/0128508 A1
(43) Pub. Date: Jun. 16, 2005

(54) System for transferring documents and resources to a printer

(75) Inventors: Esaias Greeff, Redmond, WA (US); Craig McLuckie, Bellevue, WA (US)

Correspondence Address: WATTS HOFFMANN CO., L.P.A.;Suite 1750, 1100 Superior Avenue, Cleveland, OH, 44114, US

(73) Assignee: Microsoft Corporation

(21) Appl. No.: 10/733,045

(22) Filed: Dec. 11, 2003

(51) Int. Cl. G06K 1/00

(52) U.S. Cl. 358/1.15

(57) ABSTRACT

A system and process for controlling printing of a print job by a printer. A print request is sent from a client to the printer. The request includes a unique source identifier for the print job; a type of the document or documents that make up the print job; an source address where a plurality of document resources can be retrieved; and printer settings to apply to the document or documents. and a printer timeout interval relating to an expected printing time. The printer can be informed of the size of the job or alternatively can operate in a streaming mode where data is sent to the printer as it becomes available. The printer responds to this initial request with an initial response that indicates if the print job request can be accepted and if it is accepted, supplying a printer identifier for the job on the printer for use by the client to subsequently identify the job on the printer. The printer submits a data request for the document data at the source address. The data request identifies a resource in the document to retrieve, an offset into a collection of resource data and an amount of resource data to retrieve. The requested document data is requested by the printer and in the event the remaining data for satisfying the data request is less than an amount requested, then all the remaining data is sent to the printer. The data sent to the printer is processed and based on the contents of the document data, an additional one or more requests for resources are sent to the client for additional document data.

### FIELD OF THE INVENTION

The present invention concerns a printer protocol for interactions between a printing device and a client such as an individual user's personal computer or a shared print server.

### BACKGROUND ART

Whenever a computer sends a document to a device (like a printer) for rendering, if that device does not have the resources to store the whole document in memory, some mechanism must be used to enable the device to render the whole document using only the limited resources available to it. In this document the term ‘print client’ is used to refer to both a personal computer and a shared print server.

For raster based document formats this is normally done by sending the documents to the device in bands or tiles. Once one band is processed, a next subsequent band is sent to the printer.

For vector based documents the problem of printing with limited resources is more complex. A document is considered to be vector based if it is described in terms of drawing primitives such as lines, curves and glyphs. Lines are characterized by a starting and an ending position on the rendering, width of the line and possibly color of the rendering. Curves add a complexity of the radius of curvature. Glyphs are pieces of symbols or characters. In the Roman alphabet there is an almost one to one correspondence between letters and their glyphs. In Arabic and east Asian written languages, a letter is commonly composed of two or more glyphs. There are more drawing primitives in typical vector languages like gradients, alpha blends, polygons etc. Vector based documents frequently embed resources like fonts or pictures and a drawing primitive can also be used to refer to these additional resources. It is often the case that neither the whole document nor the whole resource or component contained within the document can be kept in memory by the rendering device or mechanism. This situation means the device must render the document and even the primitives piece meal.

A prior art technique has been to format the document in such a way that document resources for a page are downloaded to the printer in a way that ensures that they are available when they are needed. In this solution the print client is in control. Elaborate mechanisms are needed in the PDL (Page Document Language) to manage the lifetime and availability of the document recourses.

For this mechanism to be robust one of the following three strategies is implemented:

1) The print client embeds the document resources for a page into every page and sends it to the printer. This works but is inefficient from a bandwidth standpoint if the resource (such as a watermark or glyphs of a font that are common to many pages) appear on many pages. If the resource requirements for a single page exceed the capability of the device the page cannot be printed.

2) The print client needs a bidirectional communication channel from the PDL generator (rendering portion of the print client driver) to the printer. To either:

2a) Monitor the amount of printer resources consumed and take action in the PDL stream to free some of the resources in the case where the PDL stream is responsible for this action.

2b) Query to see if a document resource that was previously sent down is still available and only send it again if it is not.

3) Lacking a bidirectional communication channel from the PDL generator, the generator can try to estimate the amount of printer resources that it is consuming and implement option 2a (above) based on this estimation. Of course this is not 100% reliable because the driver can never be sure quite how a printer implements the PDL.

One advantage of the third option (the option that the Windows operating system such as WindowsXP® presently implements) is that the communications between print client and printer only needs to be unidirectional.

Using the third strategy, when an application program wants to begin using a printer, the application first obtains a handle to the printer device context which causes the printer device driver library module (files with .DLL extensions and other data files) to be loaded into memory and initialize itself. The printer driver is assisted by the operating system graphics to render to PDL. The resulting demand on printer resources can be high even for a single page. To solve this problem one prior art approach is to subset fonts and possibly reduce the size of images. The possibility of especially the third strategy swamping the printer with data it cannot handle (resulting in an error message and abort of the printing) is counterbalanced by the simple, essentially one way communications between client and printer which is an advantage when transmitting data from a parallel printer port or an existing network to which a printer is connected.

### SUMMARY OF THE INVENTION

An exemplary system controls rendering of text, images etc on a device. A communications channel is established to provide at least a half duplex or better bi-directional communications path between a client and the device. In one typical application, the device is a printer for imprinting text images etc on paper. The client can be a computer configured as a client, i.e. a node running client software on a network or alternately can be a single computer communicating by means of one of a number of possible communications protocols. The printing device includes print resources for storing print data and rendering an image based on data sent to the printing device by the print client through the bi-directional communications path.

The client initiates rendering by the printing device by sending a initial request for print services relating to a print job. In accordance with one embodiment this initial request indicates an amount of data in the print job and characteristics of that data. This initial request is acknowledged by the printing device and an initial amount of data is requested. The print client responds by sending an initial amount of data and awaiting additional requests for more data or in the event all print data of a print job is sent in response to the initial request, awaiting an indication that printing of that print job has been completed.

In accordance with an alternate embodiment, the initiator of the job does not know the amount of data to sent at job initialization time. Nonetheless, the printer needs to be able to operate in a ‘streaming’ mode wherein the initiator informs the printer to keep requesting data until there is no more data left to print. This premise is similar to the aforementioned embodiment, but a difference is that the printer keeps making requests for data at a page level until there is none left to send and the client responds with a no more data (NAK) message.

These and other objects, advantages and features of the invention are described in conjunction with the accompanying drawings.

### BRIEF DESCRIPTION OF THE DRAWINGS

FIG. 1 is a schematic depiction of an exemplary computer system;

FIG. 2 is a schematic of a printer and a print client communicating by means of a communications path;

FIG. 3 is a schematic depiction of a sequence of communications between a printer and a print client during the printing of a print job;

FIGS. 4A and 4B depict printers having different resources for printing a print job; and

FIG. 5 is a schematic depiction of a print job stored on a print client.

### EXEMPLARY MODE FOR PRACTICING THE INVENTION

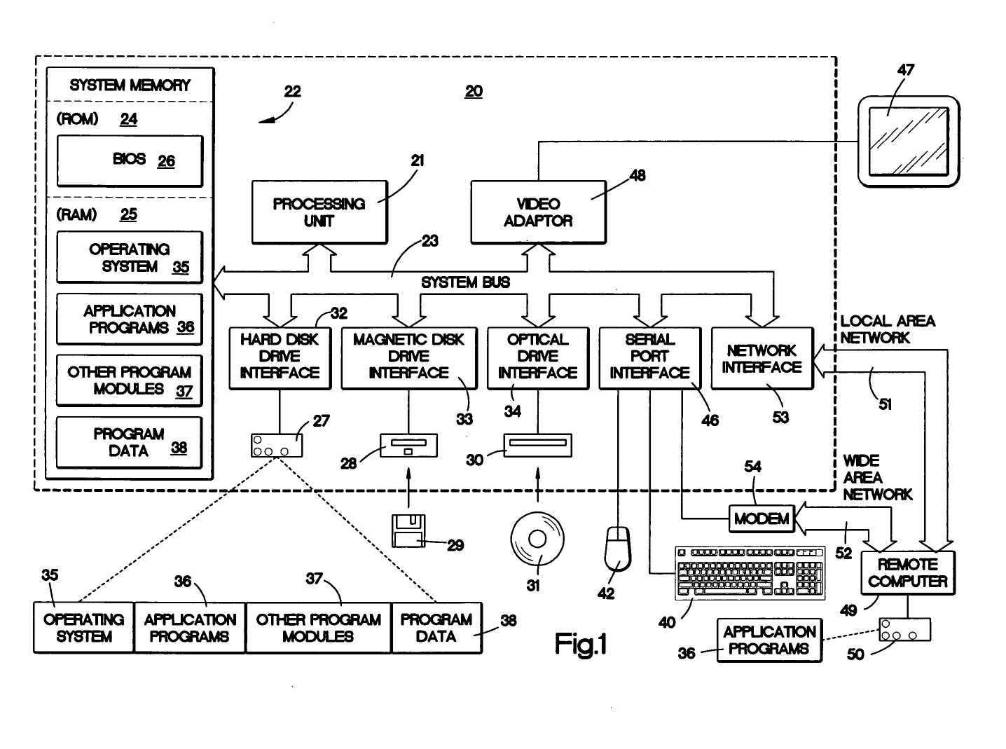

Turning to the drawings, therein is depicted an exemplary embodiment of the invention. The task addressed by the invention is a process of transferring a document for rendering to a device such as a printer. FIG. 2 depicts a typical printing scenario. A print client 102 is in communications with a printer 104 by means of a communications path 106. A communications session between the computer and the printer is implemented over any communication channel that can support query/response type communication. Examples are TCP, USB, 1394, Bluetooth, HTTP, SSL. Any half-duplex or better channel can be used. HTTP is particularly well suited as a carrier for this exemplary embodiment of the invention. Additional details of an exemplary print client 102 are described in relation to FIG. 1.

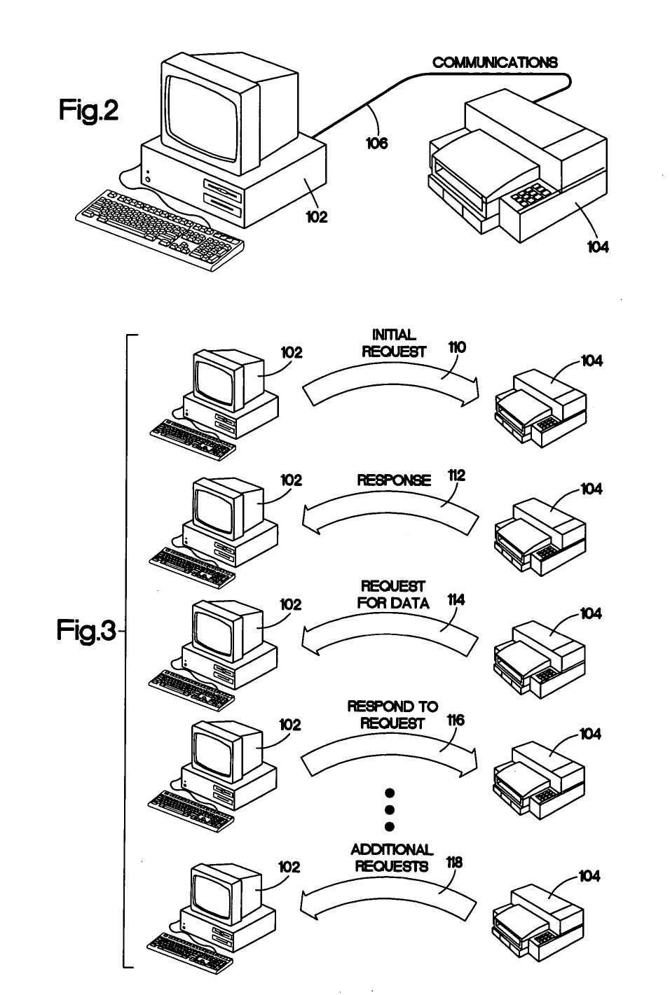

The printing task is implemented by means of back and forth communications (FIG. 3) between the device that wants to print the document (most likely a print client or PC 102 from here on referred to as the client) and a printer. The print client sends an initial request 110 to the printer 104. In one exemplary embodiment the initial request contains: a) A unique identifier for the print job; b) The type of the document; and c) an address (most likely the client's address) where the document resources can be retrieved. Note, although this may be the address of the computer, it is also possible that the address can be the address of another computer or resource available through a separate communications channel in communication with the printer 104.

The initial request 10 also includes printer settings to apply to the document such as the page range to print, number of copies etc. Metadata about the document such as its total size is also sent to the printer. Finally, the initial request includes a timeout printer heartbeat. The heartbeat lets the client know that the printer has the job queued or is actually printing the job. The printer sends a message to the client periodically (specified by the timeout) informing the client that the print job request is still being honored. This gives the client the ability to know if the job is abandoned for some unforeseen reason such as the printer losing power.

The printer 104 replies to the request from the client with a response 112 that indicates if the document print request can be accepted. If the print job is accepted the response 112 also includes a unique identifier for the print job on the printer 104. If the print job is accepted, the client assumes that the printer will honor the request in the future. It is possible that the printer may queue several jobs. The client 102 can use this identifier to later manipulate the document on the printer through management protocols. The printer 104 may be coupled to a network and may receive requests to print numerous print jobs from other sources and therefore each job is assigned a unique job identifier by the printer and in turn the printer knows the unique print job designator assigned to that job by the client.

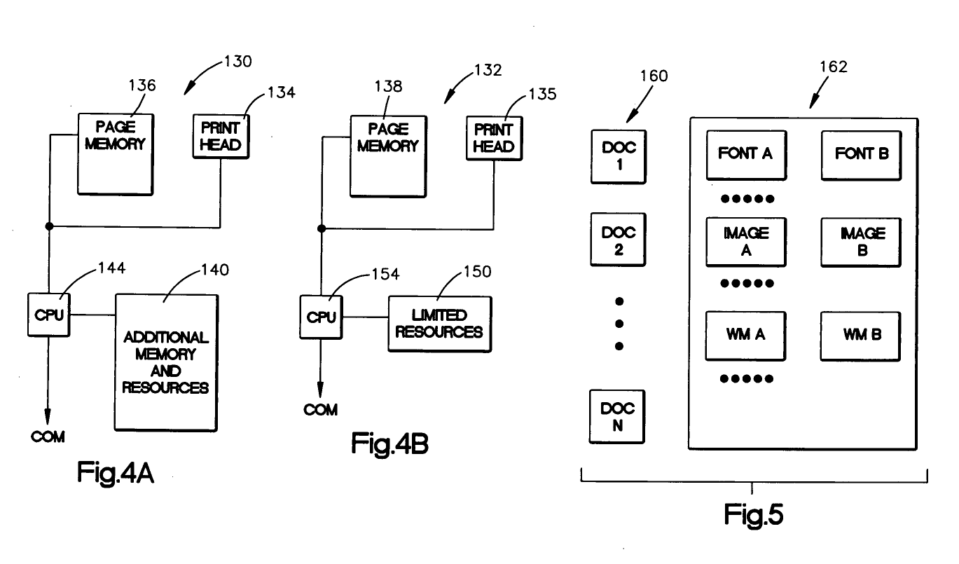

Consider the resources of two printers 130, 132 depicted in FIGS. 4A and 4B. Each printer includes a print head 134, 135 for rendering an image based on data sent to the print head by its respective printer. A representative print head could include a laser or ink jet print head. The two printers 130, 132 also includes a region of memory 136, 138 for formatting a page of the document of a print job. In both printers this memory 136, 138 is approximately the same size and for a typical printer might include several megabytes of RAM.

The printer 130 has additional printer resources 140 that include additional high speed memory, a hard drive and possibly a special graphics processor. The printer 130 also includes computational hardware 144 for manipulating the data received from the client and formatting that data for transferal to the memory 136. The printer 132 has more limited resources 150 including perhaps a small amount of additional memory. Computational hardware 154 in the second printer 132 also receives data from the client and organizes it in a format for storage in the memory 138.

The printer 130 is more powerful than the printer 132 in the sense that it has more resources. It has the capacity to completely store for example all resources for multiple print jobs from multiple sources. The printer 132 is more limited. It has resources for only part of any print job that takes up more than a page of text. For certain raster printers, a printer may not have enough resources to store even one page of content. Such printers are forced to band/tile pages of content as they print each page.

Once the printer is ready to render the document, it sends a request 114 for the document data at the address specified by the client. In the interchange of data depicted in FIG. 3, the client and the address at which the data is found are the same. The request 114 identifies the document based on the information sent from the client. In accordance with one embodiment of the exemplary system, the data request 114 is a 3 tuple (x,y,z) where x identifiers the resource in the document to retrieve, y is an offset into the resource data and z is the amount of data to retrieve, starting at y. Other format of requests are possible without departing from the scope of the invention. As an example, a range of glyphs could be requested by the printer. Due to the differences in capability between the two printers 130, 132 this request will be quite different for different printers. The printer may reference resources needed to print by a URI (Universal Resource Indicator?). The computational hardware of the printer can request resources with scoping and attribute information contained in the request (length, data format, compression level, image resolution, etc) that the returned data from the client should conform to.

The description x of a document resource is tied to the document format. The printer knows the format since it was informed of the format in the initial request 110. The printer must understand the document format. When the print job starts for example the printer will ask for the page description of the first page to be printed, at offset zero and specify some convenient size for the data to be retrieved. Later it may ask for other resources in the document.

FIG. 5 illustrates a print job 160 made up of multiple documents, each of which may include multiple pages. One example of a document is a document formatted in accordance with the XML markup language. Each document page may include embedded ascii text as well as details of the text font, pitch etc. Furthermore, the page may include reference to images (jpeg, bmp etc) at locations defined by XML tags in the document that are not part of the document but are stored on the client in a catalog or folder of resources 162. It is also possible that a document file exists on the client or data source and that the ascii and other resources are stored in a single document file in different data streams.

The client response 116 to this request includes the data requested by the printer 104. If the remaining data needed to complete the job is less than the amount requested naturally, less data than requested is returned. In some circumstances, the printer will not know the job size on initiation of the request 110. There is therefore a need for the printer and client to be able to implement a streaming mode wherein the printer asks for more data at a page level until there is no additional data to send. An example of such a need is a batch run for a payroll job with thousands of entries. The full length of the data for the print job is not known by the client when the job is started. In this alternate embodiment the client needs the ability to send an initial request 110 without a specified size designated for the job.

Upon, receipt the printer processes the data and based on what the data contains, it issues further or additional requests 118 to the client 104 for additional data. If a page contains a picture or possibly a font, the printer request may request the font or picture again. This can occur if, due to a lack of resources at the printer such data was previously used to format a page but due to a need in formatting other pages (possibly due to needs of other print jobs from other sources) was discarded.

Generally, the printer and the client organize data into pages. When the printer 132 having limited resources has printed a page, it issues a request to retrieve data for the next page. Even this request can be complicated since in a printer with limited resources such as the printer 132, the request may interleave text and image data for example, and load the data a band at a time into the dedicated page memory 138. The request for data by the printer and the response with data from the client to the printer are repeated until the whole job as requested has been printed. The printer 130 may, if not overburdened with other jobs, just ask for all resources for the job 160 in its request for data 114. Since the printer 130 has large resources for storing data, details of the font or even images may already be stored in the resource area 140 of the printer 130.

In accordance with one mode of operation, the printer is sent the document size in the initial request 110 so it can decide (based on the size of the document and page range) if it has enough resources to short circuit the back and forth dialog shown in FIG. 3. The printer can ask for all resources in one request 114. This is an optimization for printers with a large amount of resources. It is most efficient since if the client wants to print the whole document and the printer has the resources then the quickest way is to receive all document resources at once.

In an alternate operating mode, the initial request 110 does not know the job or document size. The printer must respond to an open ended request or ‘stream’ mode in addition to the full document printing mode where it keeps requesting data until there is none left to send. The client will only start sending a new page when all the data for that page is available. When there are no more pages available, the client sends a ‘no more data’ message and the printer terminates the printing operation.

In the first embodiment, there is an underlying assumption that the document is already complete when the printer is asked to start printing or that the content of the document (whose size is known) is created faster than the printer can consume it. This is generally true but not always. To solve this potential problem, two concepts are introduced.

Whenever the printer sends a request for a resource 114, the response 116 from the client can state that the resource is not available. This response includes a timeout. The printer stops processing the job at this point. The print client must now send another request to the printer when the requested data becomes available. The printer's responds to the resource available message with an acknowledgement. The printer now resumes the job by re-sending the request for resources. If the resource does not become available within the timeout but content is still being added to the document then the client resets the timeout by sending another resource not available request with a new timeout. The printer continues to wait.

Every response 116 to a resource request has a flag that indicates whether or not content is still being added to the document. This is important for the case where the printer is asked to print the whole document and the printer consumes the document faster than it is being created. The printer can keep on asking for the next page. If the page does not exist yet then the client responds with a content unavailable message. The printer knows that all pages are printed when it sees a response without the content being added flag set. All response packets to resource requests should have the flag set correctly.

Printers have varying resources and one feature of the invention is the ability to handle the case wherein the printer asks for resources of the document or job a piece at a time. In a simple example, the printer asks for 1000 bytes of the first page of a document and then asks for the next 1000 bytes etc. until it reaches the end of page 1. In a more realistic scenario, the document format includes a page index with page size and page descriptions that will include imbedded resource sizes for resource references to make communications between the client and the printer efficient.

The printer sends the client a request 118 that identifies that the job has been completed. If at any time the client fails to respond to a request from the printer or responds that a document does not exist (indicating that the document has probably been cancelled) the printer must cancel the job. The printer is allowed to retry the request if it deems it appropriate.

The series of communications interactions shown in FIG. 3 illustrate a basic format for printing documents. Certain enhancements are contemplated that provide added features to the basic idea. If the printer 104 determines from the metadata sent by the client 102 that it has enough resources to handle an entire document, the printer can make a request to transfer the whole document.

Once a powerful printer such as the printer 130 has downloaded a resource or part of the resource, it can store it in a hit cache. Resources age out of the cache when they are not used or when new resources are added to the cache. In this scenario the printer first checks the cache when it needs to issue a request for a resource. This cuts down on the traffic, reduces the chattiness for the protocol and enhances the performance of the rendering.

Computer System

FIG. 1 depicts an exemplary data processing device. A data processing device shown in FIG. 1 can act as the client 102. A device such as that depicted in FIG. 1 can also serve as computation hardware for a more powerful printer such as the printer 130. The system includes a general purpose computing device in the form of a conventional computer 20, including one or more processing units 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures.

The system memory includes read only memory (ROM) 24 and random access memory (RAM) 25. A basic input/output system 26 (BIOS), containing the basic routines that helps to transfer information between elements within the computer 20, such as during start-up, is stored in ROM 24.

The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROM), and the like, may also be used in the exemplary operating environment.

A number of program modules may be stored on the hard disk, magnetic disk 29, optical disk 31, ROM 24 or RAM 25, including an operating system 35, one or more application programs 36, other program modules 37, and program data 38. A user may enter commands and information into the computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. In addition to the monitor, personal computers typically include other peripheral output devices (not shown), such as speakers and printers.

The computer 20 may operate in a networked environment using logical connections to one or more remote computers, such as a remote computer 49. The remote computer 49 may be another personal computer, a client, a router, a network PC, a peer device or other common network node, and typically includes many or all of the elements described above relative to the computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the computer 20 is connected to the local network 51 through a network interface or adapter 53. When used in a WAN networking environment, the computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used.

Although the exemplary embodiment of the invention has been described with a degree of particularity, it is the intent that the invention include all modifications and alterations from the disclosed design falling within the spirit or scope of the appended claims.

1. A method of controlling rendering by a device comprising:
a) providing at least a half duplex or better bi-directional communications path between a client and a rendering device; said device including resources for storing data and rendering an image based on data sent to the device by the client through the bi-directional communications path; and
b) co-ordinating rendering by the device by:
i) sending a initial request for services relating to a job to said device that indicates characteristics of said job;
ii) acknowledging the initial request and requesting rendering data to be sent; and
iii) in response to the request for rendering data, sending rendering data and awaiting additional requests for more data or in the event all data of a job has been sent to the rendering device awaiting an indication that rendering of said job has been completed.

2. The method of claim 1 wherein the characteristics sent with the initial request includes an amount of data for the job.

3. The method of claim 1 wherein the initial request indicates that an amount of data in the job is not known.

4. The method of claim 1 and wherein the data sent to the device includes a data unavailable indicator which indicates to the device data for said job is presently not available and further including a timeout during which the device suspends processing of said job until the data becomes available.

5. The method of claim 1 wherein the client sends data to the rendering device when said data is made available to said client and wherein the rendering device awaits receipt of more data or an end of data indicator.

6. The method of claim 1 wherein the device discards data already sent to the device to accommodate additional data from the print client.

7. The method of claim 6 wherein the device makes a request for retransmission of data that was previously discarded during rendering of the job for subsequent use in rendering.

8. The method of claim 1 wherein the rendering device is a printer and the data is organized into pages by the client and wherein the requests for data sent by the printer to the client fulfills the needs for printing one or more pages.

9. The method of claim 8 wherein the initial request includes an amount of data in the job and wherein in the event the printer determines from the initial request sent by the client that it has enough resources to handle an entire document, the printer requests a transfer data for printing an entire document.

10. The method of claim 1 wherein the rendering device is a printer and said printer comprises a memory which stores document resources or a part of a document resource and wherein the printer maintains a hit cache and deletes resources from the cache when that have not been recently used when new resources are added to the cache.

11. The method of claim 10 wherein the printer first checks the cache when it needs to issue a request for a resource.

12. The method of claim 1 wherein asking for rendering data in response to the initial request is performed either substantially immediately or after a delay due to utilization of resources for rendering of data from other clients.

13. A process for controlling printing of a print job by a printer comprising:
sending a print job request from a client to the printer, said request comprising: a unique source identifier for the job; a type of document or documents that make up the print job; an source address where a plurality of document resources can be retrieved;
printer settings to apply to the document or documents; metadata concerning the document or documents; and a printer timeout;
replying to the request with an initial response that indicates if the document print request can be accepted and if it is accepted, supplying a printer identifier for the print job on the printer for use by the client to subsequently identify the print job on the printer;
submitting a data request for document data at the source address; said data request identifying a resource in the document to retrieve, and an amount of resource data to retrieve;
transmitting the requested document data to the printer; and
processesing the data at the printer and based on the contents of the document data issuing an additional request to the client for additional document data.

14. The process of claim 13 wherein the metadata includes a size and type of the document or documents.

15. The process of claim 13 wherein the data request includes an offset into a collection of resource data.

16. The process of claim 15 wherein the collection of resource data is a glyph or a range of glyphs.

17. The process of claim 13 wherein the resource contains a picture or a font and wherein the printer issues a new request to retrieve the data for the font or picture.

18. The process of claim 13 wherein the printer formats a page at a time and after each page the printer issues a request to retrieve data for the next page.

19. The process of claim 13 wherein request for print resources are repeated until an entire job has been printed.

20. The process of claim 13 wherein the printer sends the client a message that indicates that the job has been completed.

21. The process of claim 13 wherein the print job request indicates a streaming mode wherein data is sent from the client to the printer as it becomes available to the client once the printer has accepted the print job.

22. The process of claim 13 wherein the initial request indicates that an amount of data in the job is not known.

23. The process of claim 13 and wherein the data sent to the printer includes a data unavailable indicator which indicates to the printer data for said job is presently not available and further including a timeout during which the device suspends processing of said job until the data becomes available.

24. The method of claim 13 wherein the client sends data to the printer when said data is made available to said client and wherein the printer awaits receipt of more data or an end of data indicator.

25. A system for printing documents comprising:
a) a client for formatting print data into pages for transmission;
b) a printer for receipt of the print data from the client and for rendering an image based on the print data;
c) a communication channel for providing at least half duplex or better bi-directional communications path between a client and the printer; said printer including print resources for storing print data and rendering an image based on data sent to the printer by the client through the bi-directional communications path; and
d) components included in the printer or the client for co-ordinating image rendering by the printer by:
i) sending a initial request for services relating to a job to said printer that indicates characteristics of said job;
ii) acknowledging the initial request and requesting print data to be sent; and
iii) in response to the request for print data, sending print data and awaiting additional requests for more data or in the event all data of a job has been sent to the printer awaiting an indication that printing of said job has been completed.

26. The system of claim 25 wherein the printer comprises a page memory for storing a page of data and further comprises a print head in communications with the page memory for rendering an image based on the contents of the page memory.

27. The system of claim 25 wherein the printer includes resources for storing print data to avoid repeated requests for print data from the print client.

28. The system of claim 25 wherein the printer comprises a memory which caches document resources or a part of a document resource and wherein the printer includes a computation device that maintains a hit cache and deletes resources from the cache when that have not been recently used when new resources are added to the cache.

29. The system of claim 28 wherein computation device of the printer first checks the cache when it needs to issue a request for a resource.

30. Apparatus for controlling rendering by a device comprising:
a) means for providing at least half duplex or better bi-directional communications path between a client and a device; said device including resources for storing data and rendering an image based on data sent to the device by the client through the bi-directional communications path; and
b) means for co-ordinating rendering by the device by:
i) sending a initial request for services relating to a job to said device that indicates characteristics of said job;
ii) acknowledging the initial request and requesting rendering data to be sent; and
iii) in response to the request for rendering data, sending rendering data and awaiting additional requests for more data or in the event all data of a job has been sent to the rendering device awaiting an indication that rendering of said job has been completed.

31. A computer readable medium containing instructions for controlling printing by a printer comprising:
a) implementing a half duplex or better bi-directional communications connection between a client and a printer that includes resources for storing data and rendering an image based on data sent to the printer by the client through the bi-directional communications path; and
b) co-ordinating printing by the printer by:
i) sending a initial request for services relating to a job to said printer that indicates characteristics of a print job;
ii) acknowledging the initial request and requesting rendering data to be sent; and
iii) in response to the request for rendering data, sending rendering data and awaiting additional requests for more data or in the event all data of a print job has been sent to the printer awaiting an indication that rendering of said print job has been completed.
